(19) United States
(12) Patent Application Publication
(10) Pub. No.: US 2014/0306079 A1
(43) Pub. Date: Oct. 16, 2014

(54) Fixing Plate

(71) Applicant: DOMMA METAL INDUSTRIAL CO., LTD., Taichung (TW)

(72) Inventor: Kuo-Yung Kuo, Taichung City (TW)

(73) Assignee: DOMMA METAL INDUSTRIAL CO., LTD., Taichung (TW)

(21) Appl. No.: 13/949,427

(22) Filed: Jul. 24, 2013

(30) Foreign Application Priority Data
Apr. 12, 2013 (TW) 102113114

(51) Int. Cl. F16M 13/02

(52) U.S. Cl. CPC F16M 13/02
USPC 248/222.14

(57) ABSTRACT

A fixing plate is disposed between a bracket head of a towel rail and a wall. A locking screw extends along an axis through the bracket head to abut against the fixing plate. The fixing plate includes a base wall fixed to the wall, and a surrounding wall. The surrounding wall extends from a periphery of the base wall away from the wall and abuts against the bracket head, and is formed with a positioning groove. The surrounding wall has a distal periphery forming an imaginary plane. A projection of the positioning groove on the imaginary plane extends in a direction of the axis. The locking screw extends into the positioning groove for being maintained to extend along the axis.

### CROSS-REFERENCE TO RELATED APPLICATION

This application claims priority of Taiwanese Application No. 102113114, filed on Apr. 12, 2013.

### BACKGROUND OF THE INVENTION

1. Field of the Invention

This invention relates to a fixing plate, more particularly to a fixing plate for mounting a bracket of a towel rail on a reference surface.

2. Description of the Related Art

Referring to FIGS. 1 and 2, a towel rail 6 includes two brackets 61 (only one is shown in FIGS. 1 and 2) which are fixed on a wall, and a rod 62 which interconnects the brackets 61. Each of the brackets 61 is mounted to a conventional fixing plate 5 which is fixed on the wall.

The conventional fixing plate 5 includes a base wall 51 and a surrounding wall 52.

The base wall 51 is fixed to the wall and is formed with a pair of through holes 53. The surrounding wall 52 extends from a periphery of the base wall 51 away from the wall, and abuts against a corresponding one of the brackets 61. Two securing screws 7 extend respectively through the through holes 53 of the base wall 51 for fixing the base wall 51 to the wall. Furthermore, each of the brackets 61 is formed with a positioning hole 611 for extension of a locking screw 8 therethrough to abut against the surrounding wall 52 of the conventional fixing plate 5.

The locking screw 8 may skew from vertical when abutting against the surrounding wall 52, which may cause tilt of the towel rail 6.

### SUMMARY OF THE INVENTION

Therefore, the object of the present invention is to provide a fixing plate to alleviate the abovementioned drawback associated with the prior art.

Accordingly, a fixing plate of the present invention is adapted to be fixed on a wall through a securing screw and is disposed between a bracket head of a towel rail and the wall. The bracket head is formed with a positioning hole. The towel rail includes at least one locking screw that extends along an axis through the positioning hole and that abuts against the fixing plate. The fixing plate includes a base wall and a surrounding wall. The base wall is adapted to be fixed to the wall, and is formed with a through hole for extension of the securing screw so as to fix the base wall to the wall. The surrounding wall extends from a periphery of the base wall away from the wall, is adapted to abut against the bracket head of the towel rail, and is formed with at least one positioning groove that corresponds in position to the positioning hole. The surrounding wall has a distal periphery that forms an imaginary plane. A projection of the at least one positioning groove on the imaginary plane extends in a direction of the axis. The at least one locking screw extends into the at least one positioning groove for being maintained to extend along the axis.

### BRIEF DESCRIPTION OF THE DRAWINGS

Other features and advantages of the present invention will become apparent in the following detailed description of the preferred embodiment with reference to the accompanying drawing.

FIG. 1 is an exploded perspective view of a conventional fixing plate and a bracket of a towel rail;

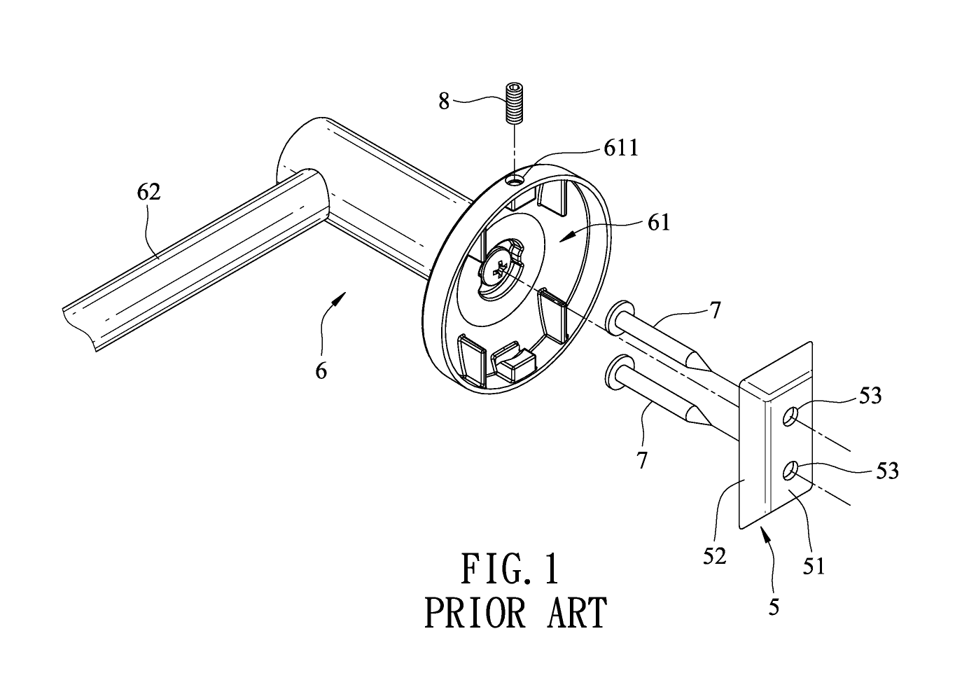

FIG. 2 is an assembled perspective view of the conventional fixing plate and the bracket of the towel rail;

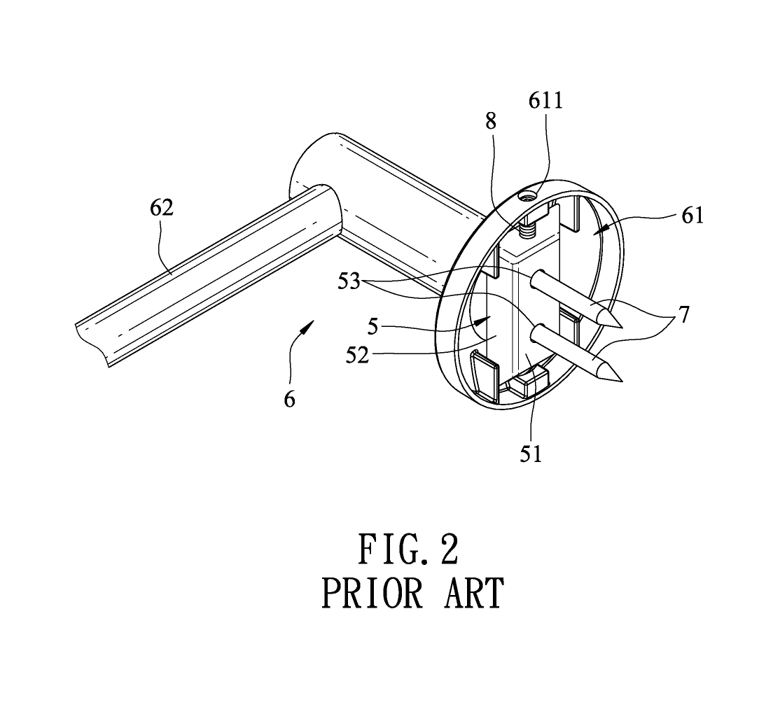

FIG. 3 is a perspective view of a preferred embodiment of a fixing plate according to the present invention;

FIG. 4 is an exploded perspective view of the preferred embodiment and a bracket of a towel rail; and

FIG. 5 is an assembled perspective view of the preferred embodiment and the bracket of the towel rail.

### DETAILED DESCRIPTION OF THE PREFERRED EMBODIMENT

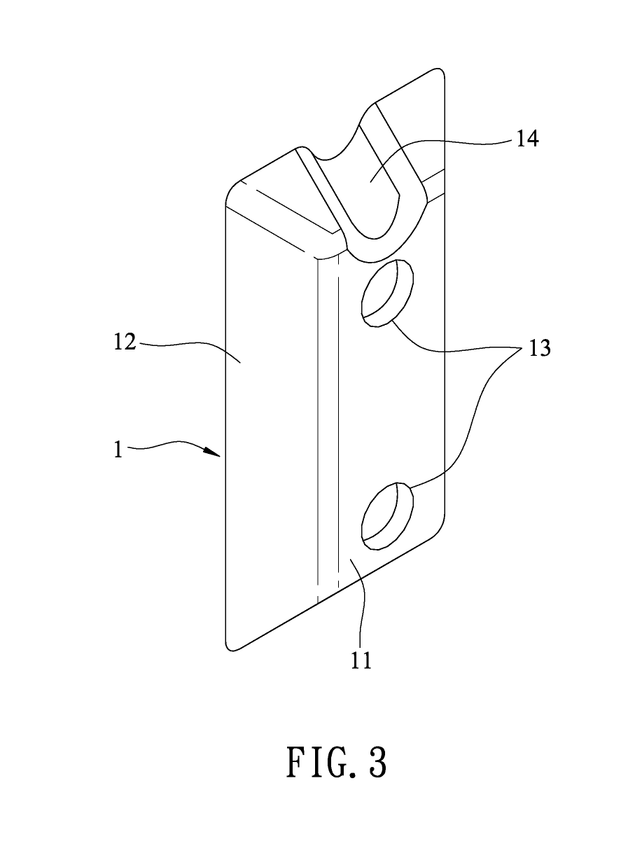

Referring to FIGS. 3, 4 and 5, a preferred embodiment of a fixing plate 1 according to this invention is adapted to be fixed on a wall through two securing screws 4 and connected to a towel rail 2.

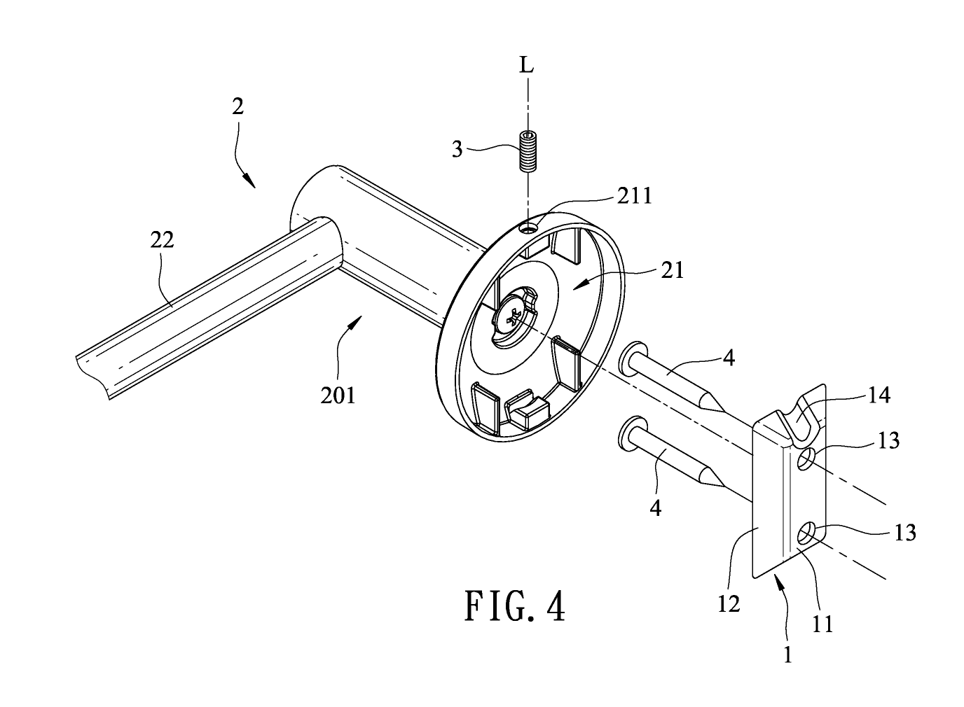

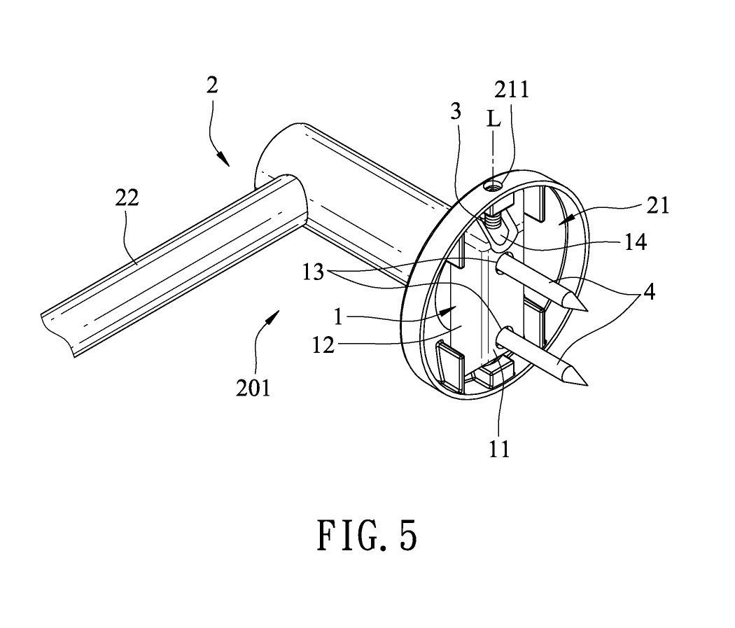

The towel rail 2 includes two brackets 201 (only one is shown in FIGS. 4 and 5) and a rod 22 interconnecting the brackets 201. Each of the brackets 201 has a bracket head 21 formed with a positioning hole 211. The towel rail 2 further includes a locking screw 3 that is extendable through the positioning hole 211 along an axis (L). Two of the fixing plates 1 are required to be fixed on the wall and to be coupled respectively to the bracket heads 21 of the brackets 201 (i.e., each of the fixing plates 1 is disposed between the bracket head 21 of a respective one of the brackets 201 and the wall).

The fixing plate 1 includes a base wall 11 and a surrounding wall 12.

The base wall 11 is quadrilateral, is fixed to the wall, and is formed with a pair of through holes 13 for extension of the securing screws 4 so as to fix the base wall 11 to the wall. The through holes 13 are spaced apart and are arranged in a direction of the axis (L).

In this embodiment, the base wall 11 is rectangular, and the periphery of the base wall 11 has a pair of parallel shorter portions and a pair of parallel longer portions that are longer than the shorter portions and that interconnect the shorter portions.

The surrounding wall 12 extends from the periphery of the base wall 11 away from the wall, is adapted to abut against the respective bracket head 21 of the towel rail 2, and is formed with a positioning groove 14 that corresponds in position to the positioning hole 211. In this embodiment, the fixing plate 1 has a shape of a frustum. The surrounding wall 12 and the base wall 11 form an obtuse angle therebetween, and the positioning groove 14 and the base wall 11 form an obtuse angle therebetween. The surrounding wall 12 has a distal periphery that forms an imaginary plane. The positioning groove 14 extends from the distal periphery of the surrounding wall 12 to one of the shorter portions of the periphery of the base wall 11. A projection of the positioning groove 14 on the imaginary plane extends in a direction of the axis (L), and the locking screw 3 extends into the positioning groove 14 for being maintained to extend along the axis (L). Specifically, the positioning groove 14 is defined by a substantially concave groove-defining surface.

Preferably, the base wall 11 is an upright rectangle. The fixing plate 1 may include two, three or four positioning grooves 14, each of which extends between one of the shorter and longer portions of the periphery of the base wall 11 and a corresponding portion of the distal periphery of the surrounding wall 12, while two, three or four of the positioning holes 211 are formed in the respective bracket head 21 with a plurality of the locking screws 3 extending respectively through the positioning holes 211 and retained respectively in the positioning grooves 14.

To sum up, during the extension of the locking screw 3 through the bracket head 21 to abut against the surrounding wall 12 of the fixing plate 1 of this invention, one end of the locking screw 3 would be retained in the positioning groove 14, thereby maintaining the locking screw 3 to extend along the axis (L) and effectively avoiding skewing as with the prior art.

While the present invention has been described in connection with what is considered the most practical and the preferred embodiment, it is understood that this invention is not limited to the disclosed embodiment but is intended to cover various arrangements included within the spirit and scope of the broadest interpretation and equivalent arrangements.

What is claimed is:

1. A fixing plate adapted to be fixed on a wall through a securing screw and disposed between a bracket head of a towel rail and the wall, the bracket head being formed with a positioning hole, the towel rail including at least one locking screw that extends along an axis through the positioning hole and that abuts against said fixing plate, said fixing plate comprising:
abase wall adapted to be fixed to the wall, and formed with a through hole for extension of the securing screw so as to fix said base wall to the wall;
a surrounding wall extending from a periphery of said base wall away from the wall, adapted to abut against the bracket head of the towel rail, and formed with at least one positioning groove that corresponds in position to the positioning hole, said surrounding wall having a distal periphery that forms an imaginary plane, a projection of said at least one positioning groove on the imaginary plane extending in a direction of the axis, the at least one locking screw extending into said at least one positioning groove for being maintained to extend along the axis.

2. The fixing plate as claimed in claim 1, wherein:
said surrounding wall and said base wall form an obtuse angle therebetween; and
said fixing plate has a shape of a frustum.

3. The fixing plate as claimed in claim 1, wherein:
said base wall is quadrilateral; and
said at least one positioning groove extends from said distal periphery of said surrounding wall to said periphery of said base wall.

4. The fixing plate as claimed in claim 3, wherein:
said base wall is rectangular, said periphery of said base wall having a pair of parallel shorter portions and a pair of parallel longer portions that are longer than said shorter portions and that interconnect said shorter portions; and
said at least one positioning groove extends to one of said shorter portions of said periphery of said base wall.

5. The fixing plate as claimed in claim 1, wherein said at least one positioning groove is defined by a substantially concave groove-defining surface.
